(19) United States
(12) Patent Application Publication
(10) Pub. No.: US 2006/0018557 A1
(43) Pub. Date: Jan. 26, 2006

(54) Apparatus and method for filtering blocking effect in an image

(75) Inventors: Hyeok-Man Kwon, Suwon-si (KR); Jae-Hong Park, Seognam-si (KR); Tae-Sun Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/188,261

(22) Filed: Jul. 22, 2005

(30) Foreign Application Priority Data
Jul. 22, 2004 (KR) 2004-57140

(51) Int. Cl. G06K 9/36

(52) U.S. Cl. 382/232

(57) ABSTRACT

Provided is an apparatus and method for filtering a blocking effect in an image, which removes the blocking effect that may occur in an image that is compressed in block units in compression and/or decompression of a moving image. The apparatus and method for filtering a blocking effect in an image involves a single blocky pattern and a double blocky pattern and uses filtering that is suitable for these patterns. Also, the method for filtering a blocking effect in an image separately filters pixels in a top field and pixels in a bottom field when a macroblock in a frame picture is coded in a field mode.

### BACKGROUND OF THE INVENTION

This application claims the priority of Korean Patent Application No. 10-2004-0057140, filed on Jul. 22, 2004, in the Korean Intellectual Property Office, the disclosure of which is incorporated herein in its entirety by reference.

1 . Field of the Invention

The present invention relates to a blocking effect in an image, and more particularly, to an apparatus and method for filtering a blocking effect in an image, which removes a blocking effect that may occur in an image that is compressed in block units in compression and/or decompression of a moving image.

2. Description of the Related Art

In compression and/or decompression of a moving image, a blocking effect may occur around boundaries between blocks (hereinafter, referred to as block boundaries) in an image that is compressed in block units. Thus, a filtering method for removing a blocking effect in an image is required. A blocking effect filtering method specified in MPEG-4 (Moving Picture Expert Group) indicates two types of domain modes, i.e., a DC offset mode and a default mode, using 10 pixels around block boundaries and selectively performing filtering on 8 pixels around the block boundaries in each mode. Determination of the two types of domain modes is performed using Equation 1.
f=Φ(v0−v1)+Φ(v1−v2)+Φ(v2−v3)+Φ(v3−v4)+Φ(v4−v5)+Φ(v5−v6)+Φ(v6−v7)+Φ(v7−v8)+Φ(v8−v9) (1).

where Φ(a)=1 if (|a|<=TH1) else 0.

Using f obtained using Equation 1, the number of cases where the difference between adjacent pixels among the 10 pixels around the block boundaries is less than a first threshold value TH1 is obtained. When the obtained number is less than a second threshold value TH2, the domain mode is determined to be the DC-offset mode. When the obtained number is not less than the second threshold value TH2, the domain mode is determined to be the default mode. When a domain is determined to be in the DC-offset mode, it is determined to be a flat domain in which the blocking effect is removed using a low pass filter having a predetermined filter coefficient. When a domain is determined to be in the default mode, frequency information around block boundaries is obtained and the size of discontinuous components included in the block boundaries is adjusted to a minimal value using the frequency information, thereby removing the blocking effect.

However, since the blocking effect filtering method specified in MPEG-4 performs filtering on domains in the same manner regardless of whether the domains are excessively compressed or little compressed, blurring may occur.

When at least one of two adjacent macroblocks (i.e., a current macroblock and a macroblock that is located above the current macroblock) in a frame picture is coded in a field mode, i.e., when at least one of them is coded using field-DCT (discrete cosine transform) or field-prediction, its top-field line and bottom-field line are coded separately. In this case, the blocking effect filtering method specified in MPEG-4, which uses Equation 1, cannot effectively remove the blocking effect in a macroblock that is coded in a field mode.

### SUMMARY OF THE INVENTION

Therefore, a need exists for filtering a blocking effect in an image that is compressed in block units in compression and/or decompression of a moving image and also prevents blurring.

A method is provided for filtering a blocking effect in an image, by which the blocking effect is effectively removed even when at least one of two adjacent macroblocks in a frame picture is coded in a field mode.

According to one aspect of the present invention, there is provided an apparatus for filtering a blocking effect in an image. The apparatus comprises a single blocky pattern searching unit, a first filtering unit, a double blocky pattern searching unit, a second filtering unit, and a third filtering unit.

The single blocky pattern searching unit searches for a single blocky pattern in a predetermined section adjacent to the boundary between image blocks. When there is a single blocky pattern in the predetermined section, the first filtering unit filters three pixels on either side of the boundary if a first filtering condition is satisfied and filters two pixels on either side of the boundary if the first filtering condition is not satisfied.

The double blocky pattern searching unit searches for a double blocky pattern in the predetermined section if there is no single blocky pattern in the predetermined section. When there is a double blocky pattern in the predetermined section, the second filtering unit filters three pixels on either side of the boundary if a second filtering condition is satisfied and filters two pixels on either side of the boundary if the second filtering condition is not satisfied.

When there is neither a single blocky pattern nor a double blocky pattern in the predetermined section or the difference between two pixels in the predetermined section is more than two times a quantization scale factor, the third filtering unit filters one pixel on either side of a boundary between 8×8 blocks if a third filtering condition is satisfied.

A single blocky pattern is where there exists a step height between two sides of the boundary between blocks and the step height is the largest around the boundary among step heights of flat patterns. Also, a single blocky pattern is where: (a) there are two pixels on either side of the boundary; (b) a step height of less than two times the quantization scale factor exists between two pixels, each being on either side of the boundary; and (c) the difference between the two pixels is less than a predetermined threshold value.

A double blocky pattern is where at least two boundaries overlap and a step height exists over two pixels and is the largest around the boundaries among step heights of flat patterns. More specifically, a double blocky pattern is where: (a) there is one pixel in the boundary region; (b) there are two pixels on either side of the boundary region; (c) a step height of less than two times the quantization scale factor exists between two pixels, each being on either side of the boundary region; and (d) the difference between the two pixels is less than a predetermined threshold value.

According to another aspect of the present invention, there is provided a method for filtering a blocking effect in an image. The method comprises (a) searching for a single blocky pattern in a predetermined section adjacent to a boundary between image blocks, (b) filtering three pixels on either side of the boundary if a first filtering condition is satisfied and filtering two pixels on either side of the boundary if the first filtering condition is not satisfied, when there is a single blocky pattern in the predetermined section, (c) searching for a double blocky pattern in the predetermined section if there is no single blocky pattern in the predetermined section, (d) filtering three pixels on either side of the boundary if a second filtering condition is satisfied and filtering two pixels on either side of the boundary if the second filtering condition is not satisfied, when there is a double blocky pattern in the predetermined section, and (e) filtering one pixel on either side of a boundary between 8×8 blocks if a third filtering condition is satisfied, when there is neither a single blocky pattern nor a double blocky pattern in the predetermined section or a difference between two pixels in the predetermined section is more than two times a quantization scale factor.

The method further comprises (b′) repeating (a) through (e) on the pixels filtered in (b).

A single blocky pattern is where there exists a step height between two sides of the boundary between blocks and the step height is the largest around the boundary among step heights of flat patterns. More specifically, the degree of flatness is the quantization scale factor divided by 8 plus 1 and the step height is less than two times the quantization scale factor. Also, a single blocky pattern is where: (a) there are two pixels on either side of the boundary; (b) a step height of less than two times the quantization scale factor exists between two pixels, each being on either side of the boundary; and (c) the difference between the two pixels is less than a predetermined threshold value.

A double blocky pattern is where at least two boundaries overlap and a step height exists over two pixels and is the largest around the boundaries among step heights of flat patterns. More specifically, a double blocky pattern is where: (a) there is one pixel in the boundary region; (b) there are two pixels on either side of the boundary region; (c) a step height of less than two times the quantization scale factor exists between two pixels, each being on either side of the boundary region; and (d) the difference between the two pixels is less than a predetermined threshold value.

According to yet another aspect of the present invention, there is provided a method for filtering a blocking effect of an image in which at least one of two adjacent blocks is coded in a field mode. The method comprises filtering two pixels included in a top field of one of the two adjacent blocks on one side of the boundary between the two adjacent blocks and two pixels included in the top field of the other block on the other side of the boundary and filtering two pixels included in the bottom field of one of the two adjacent blocks on one side of the boundary between the two adjacent blocks and two pixels included in the bottom field of the other block on the other side of the boundary.

### BRIEF DESCRIPTION OF THE DRAWINGS

The above and other features of the present invention will become more apparent by describing in detail exemplary embodiments thereof with reference to the attached drawings in which:

FIG. 1 shows a schematic block diagram of an apparatus for filtering a blocking effect in an image according to an exemplary embodiment of the present invention;

FIG. 2 shows a flowchart illustrating a method for filtering a blocking effect in an image according to an exemplary embodiment of the present invention, which is implemented in the apparatus for filtering a blocking effect in an image shown in FIG. 1;

FIG. 3 shows pixel distribution around a horizontal block boundary and a vertical block boundary;

FIG. 4 shows a single blocky pattern and a first filtering condition;

FIG. 5 shows a double blocky pattern and a second filtering condition;

FIG. 6 shows a flowchart illustrating a method for filtering a blocking effect in an image according to an exemplary embodiment of the present invention when at least one of two adjacent macroblocks is coded in a field mode.

### DETAILED DESCRIPTION OF THE PREFERRED EMBODIMENTS

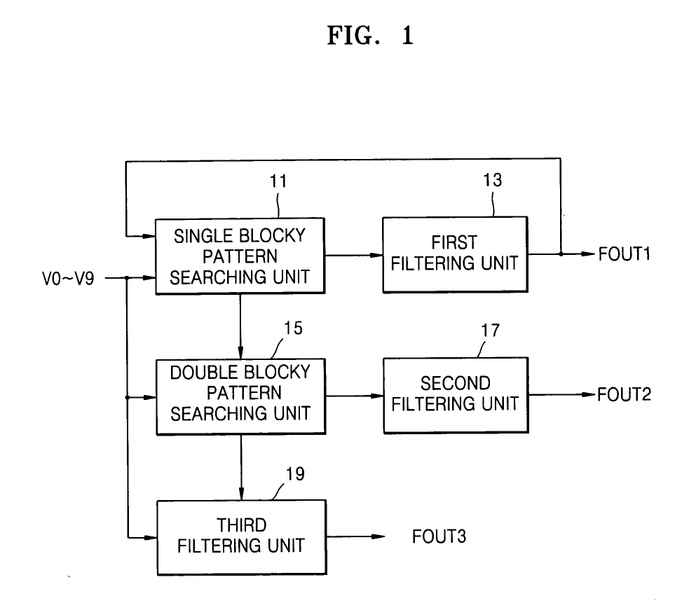

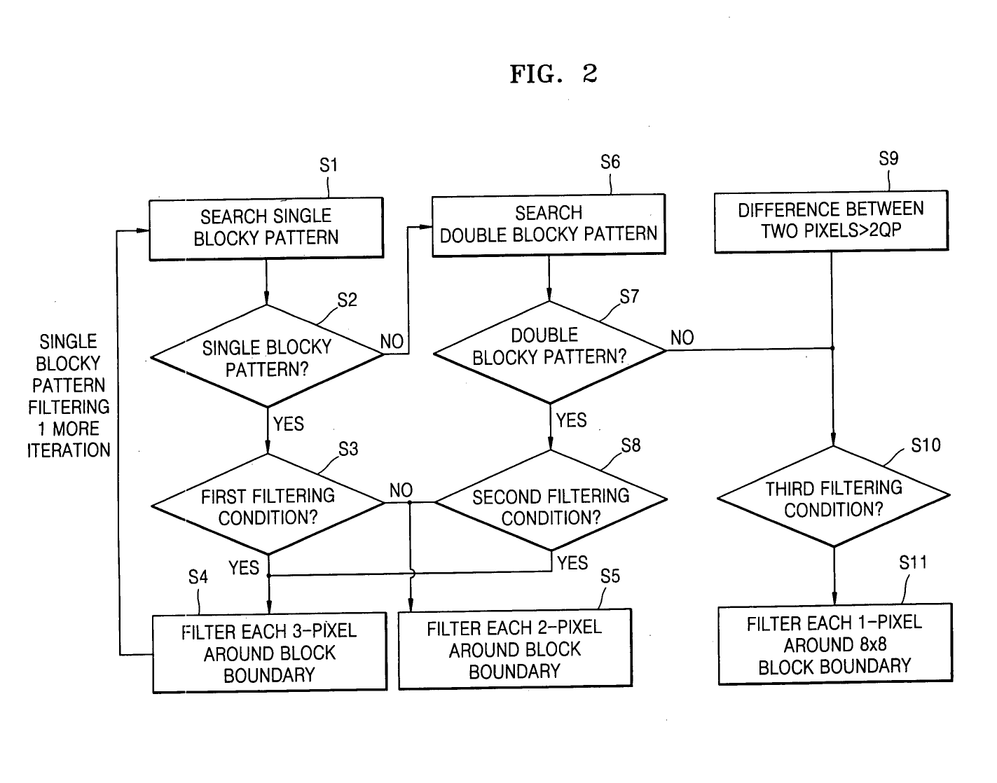

FIG. 1 shows a schematic block diagram of an apparatus for filtering a blocking effect in an image according to an exemplary embodiment of the present invention, and FIG. 2 shows a flowchart illustrating a method for filtering a blocking effect in an image according to an exemplary embodiment of the present invention, which is implemented in the apparatus for filtering a blocking effect in an image shown in FIG. 1.

Referring to FIG. 1, the apparatus for filtering a blocking effect in an image according to the present invention includes a single blocky pattern searching unit 11, a first filtering unit 13, a double blocky pattern searching unit 15, a second filtering unit 17, and a third filtering unit 19.

Hereinafter, the method for filtering a blocking effect in an image, which is implemented in the apparatus for filtering a blocking effect in an image shown in FIG. 1, will be described in detail with reference to the flowchart illustrated in FIG. 2.

The single blocky pattern searching unit 11 searches for a single blocky pattern in a predetermined section adjacent to a boundary in steps S1 and S2. The predetermined section includes 10 pixels V₀ through V₉ as shown in FIG. 3 that shows the distribution of pixels adjacent to the horizontal and vertical block boundaries.

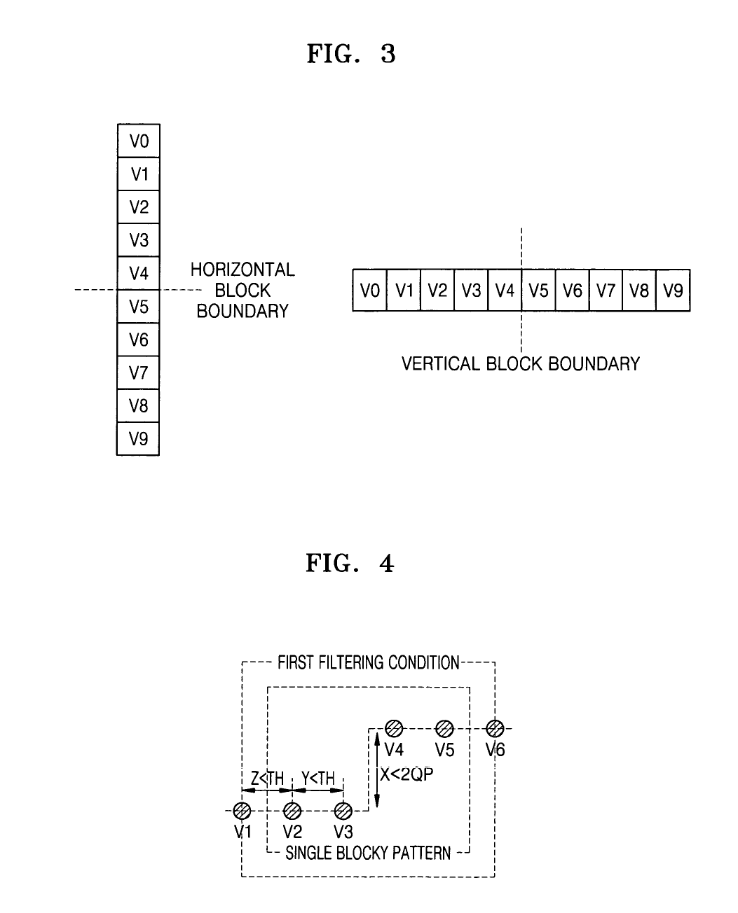

Here, a single blocky pattern is as shown in FIG. 4 such that a step height X of less than 2QP exists between two sides of a boundary and is the largest around the boundary among step heights of flat patterns, where QP indicates a quantization scale factor. The single blocky pattern is caused by a blocking effect. The degree of flatness is determined by QP and is QP/8+1. More specifically, a single blocky pattern is where: (a) there are two pixels on either side of the boundary, i.e., two pixels V₂ and V₃ are on one side of the boundary and two pixels V₄ and V₅ are on the other; (b) the step height X of less than 2QP exists between two pixels, i.e., between pixels V₂ and V₅ and between pixels V₃ and V₄; and (c) the differences Y between pixels V₂ and V₃ and between pixels V₄ and V₅ are each less than a predetermined threshold value TH.

Thus, in the method for filtering a blocking effect in an image according to the present invention, by tightening the standards for a pattern as QP decreases, less filtering takes place in a little-compressed image in which QP is small. As a result, blurring does not occur in delicate portions of an image. The reason why the step height X is less than 2QP in the single blocky pattern is that it is possible to determine that a single blocky pattern is generated due to a blocking effect caused by quantization only when the step height X is less than 2QP. Thus, a pattern in which the step height X is less than 2QP is subject to filtering.

A pattern in which the step height X is less than 2QP is mainly generated due to a quantization error between blocks when intra-coded. When the generated pattern is inter-coded and is thus motion-compensated, a single blocky pattern is generated as a block boundary moves. When the generated pattern is motion-compensated one more iteration, a plurality of single blocky patterns may be generated in the predetermined section including pixels V₀ through V₉. However, in the method for filtering a blocking effect according to the present invention, as will be described later, since filtering is performed on 6 pixels at a time, all sections in which a blocking effect occurs can be filtered by searching for two single blocky patterns in the predetermined section including pixels V₀ through V₉ and filtering the found two single blocky patterns.

Referring back to FIGS. 1 and 2, when a single blocky pattern is present in the predetermined section including pixels V₀ through V₉, the first filtering unit 13 filters three pixels on either side of the boundary, and if a first filtering condition is not satisfied, the first filtering unit 13 filters two pixels on either side of the boundary, in steps S3 through S5. In other words, if the first filtering condition is satisfied, the first filtering unit 13 filters three pixels on either side of the boundary, i.e., three pixels V₁, V₂, and V₃ on one side of the boundary and three pixels V₄, V₅, and V₆ on the other. If the first filtering condition is not satisfied, the first filtering unit 13 filters two pixels on either side of the boundary, i.e., two pixels V₁ and V₂ on one side of the boundary and two pixels V₄ and V₅ on the other. Here, the first filtering condition is that differences Z between pixels V₂ and V₃ and between pixels V₅ and V₆ are each less than a predetermined threshold value TH, as shown in FIG. 4.

After filtering is performed in steps S3 through S5, steps S1 through S5 are repeated with respect to the filtered pixels. At this time, a search is performed for another single blocky pattern that is located in another location in the predetermined section including pixels V₀ through V₉.

If another single blocky pattern is not present in the predetermined section V₀ through V₉, the double blocky pattern searching unit 15 searches for a double blocky pattern in the predetermined section including pixels V₀ through V₉, in steps S6 and S7.

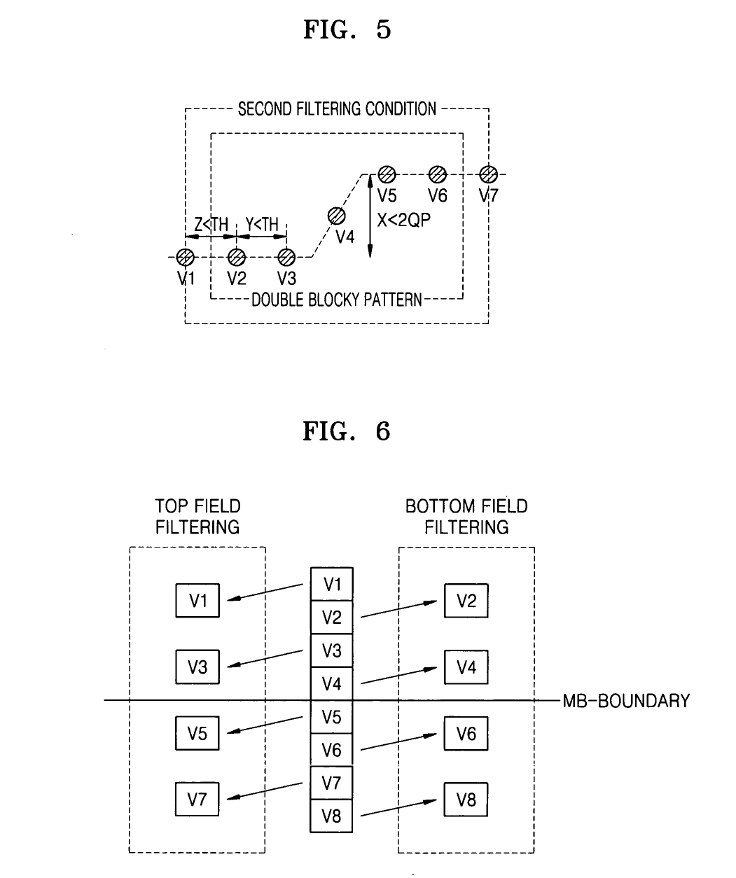

Here, a double blocky pattern is as shown in FIG. 5 such that at least two boundaries overlap and a step height X exists over two pixels and is the largest around the boundaries among step heights of flat patterns. The double blocky pattern is caused by a blocking effect. A double blocky pattern is mainly generated due to an overlap of boundaries when a motion-compensated block is motion-compensated again after inter-coding. The degree of flatness is determined by QP and is QP/8+1, like with the single blocky pattern. More specifically, the double blocky pattern is where: (a) there is a pixel V₄ in a boundary region; (b) there are two pixels on either side of the boundary region, i.e., two pixels V₂ and V₃ are on one side of the boundary region and two pixels V₅ and V₆ are on the other; (c) a step height X of less than 2QP exists between two pixels, i.e., between pixels V₂ and V₆ and between pixels V₃ and V₅; and (d) differences Y between pixels V₂ and V₃ and between pixels V₅ and V₆ are each less than the predetermined threshold value TH.

Referring back to FIGS. 1 and 2, when a double blocky pattern is present in the predetermined section including V₀ through V₉, the second filtering unit 17 filters three pixels on either side of the boundary if a second filtering condition is satisfied and filters two pixels on either side of the boundary if the second filtering condition is not satisfied, in steps S8, S4, and S5. In other words, if the second filtering condition is satisfied, the second filtering unit 17 filters three pixels on either side of the boundary, i.e., the three pixels V₁, V₂, and V₃ on one side of the boundary and the three pixels V₅, V₆, and V₇ on the other. If the second filtering condition is not satisfied, the second filtering unit 17 filters two pixels on either side of the boundary, i.e., the two pixels V₂ and V₃ on one side of the boundary and the two pixels V₅ and V₆ on the other. Here, the second filtering condition is that differences Z between pixels V₁ and V₂ and between pixels V₆ and V₇ are each less than the predetermined threshold value TH, as shown in FIG. 5.

When there is no double blocky pattern in the predetermined section including pixels V₀ through V₉, i.e., neither a single blocky pattern nor a double blocky pattern exist, or the step height X between two pixels is more than 2QP, if a third filtering condition is satisfied, the third filtering unit 19 filters one pixel on either side of an 8×8 block boundary, in steps S9 through S11. In other words, the third filtering unit 19 filters one pixel V₄ on one side of the vertical or horizontal block boundary shown in FIG. 3 and one pixel V₅ on the other.

Since a blocking effect in an image may occur due to a quantization error caused by residual components in an 8×8 block boundary when motion compensation is performed after inter-coding, steps S9 through S11 are performed to remove such a blocking effect that is not removed by performing filtering with respect to the single blocky pattern and double blocky pattern. In this case, the blocking effect is not serious, and filtering is only performed on one pixel on either side of the 8×8 block boundary.

FIG. 6 shows a flowchart illustrating a method for filtering a blocking effect in an image according to an exemplary embodiment of the present invention when at least one of two adjacent macroblocks is coded in a field mode. When at least one of two macroblocks is coded in a field mode, a method for filtering a blocking effect in an image according to the present invention filters two pixels V₁ and V₃ included in a top field of a macroblock on one side of a macroblock boundary (indicated as MB-boundary in FIG. 6) and two pixels V₅ and V₇ included in a top field of a macroblock on the other and filters two pixels V₂ and V₄ included in a bottom field of the macroblock on one side of the macroblock boundary and two pixels V₆ and V₈ included in a bottom field of the macroblock on the other.

More specifically, in the case of an interlacing picture, a macroblock can be coded in a field or a frame mode. However, when a macroblock is coded in a field mode, if the method for filtering a blocking effect in an image shown in FIG. 2 is used, patterns do not meet the first and second filtering conditions for a single blocky pattern and a double blocking pattern. As a result, filtering is not performed well.

Also, when a macroblock is coded in a field mode, i.e., the macroblock is coded using field-DCT or field-prediction, pixels included in a top-field line of the macroblock and pixels included in a bottom-field line of the macroblock are coded separately. Thus, in this case, differences between the pixels included in the top-field line and the pixels included in the bottom-field line are large. As a result, the filtering method prescribed in MPEG-4 that uses Equation 1 cannot effectively remove a blocking effect in the macroblock that is coded in a field mode.

Therefore, when a macroblock is coded in a field mode, as shown in FIG. 6, pixels V₁, V₃, V₅, and V₇ included in the top field and pixels V₂, V₄, V₆, and V₈ included in the bottom field should be filtered separately. In other words, pixels V₁, V₃, V₅, and V₇ included in the top field are filtered, and separately from them, pixels V₂, V₄, V₆, and V₈ included in the bottom field should be filtered.

However, considering the bus-bandwidth of hardware, it is necessary to receive decompressed picture data from a compression/decompression unit and to deblock the decompressed picture data on the fly, rather than storing picture data that is compressed and decompressed by the compression/decompression unit in an external memory, retrieving the stored picture data, and then deblocking the picture data. Thus, in this case, to use the minimum hardware resources, only a macroblock boundary is filtered.

Hereinafter, an example of filtering performed using a method for filtering a blocking effect in an image according to the present invention shown in FIGS. 2 through 6 will be described. When a block boundary exists on the left side of or above a predetermined pixel Vₙ in a predetermined section including pixels V₀ through V₉, if a filtering condition is satisfied, filtering is performed using Equations 2 through 4. If a filtering condition is not satisfied, filtering is performed using Equations 5 and 6.
Vₙ′=(Vₙ₋₂+2Vₙ₋₁+2Vₙ+2Vₙ₊₁+Vₙ₊₂)/8 (2)
Vₙ₋₁^{′}′=(2Vₙ₋₂+2Vₙ₋₁+2Vₙ+2Vₙ₊₁)/8 (3)
Vₙ₋₂′=(2Vₙ₋₃+3Vₙ₋₂+Vₙ₋₁+Vₙ+Vₙ₊₁)/8 (4)
Vₙ′=(2Vₙ₋₁+4Vₙ+2Vₙ₊₁)/8 (5)
Vₙ₋₁′=(4Vₙ₋₁+3Vₙ+Vₙ₊₁)/8 (6)

In Equations 2 through 6, Vₙ₋₃, Vₙ₋₂, Vₙ₋₁, Vₙ, Vₙ₊₁, and Vₙ₊₂ indicate the values of pixels before filtering and Vₙ₋₂′, Vₙ₋₁′, and Vₙ′ indicate the values of pixels after filtering.

When a block boundary exists on the right side of or below a predetermined pixel Vₙ₊₁ in a predetermined section including pixels V₀ through V₉, if a filtering condition is satisfied, filtering is performed using Equations 7 through 9. If a filtering condition is not satisfied, filtering is performed using Equations 10 and 11.
Vₙ₊₁′=(Vₙ₊₃+2Vₙ₊₂+2Vₙ₊₁+2Vₙ+Vₙ₋₁)/8 (7)
Vₙ₊₂′=(2Vₙ₊₃+2Vₙ₊₂+2Vₙ₊₁+2Vₙ)/8 (8)
Vₙ₊₃′=(2Vₙ₊₄+3Vₙ₊₃+Vₙ₊₂+Vₙ₊₁+Vₙ)/8 (9)
Vₙ₊₁′=(2Vₙ₊₂+2Vₙ₊₁+2Vₙ)/8 (10)
Vₙ₊₂′=(4Vₙ₊₂+3Vₙ₊₁+Vₙ)/8 (11)

In Equations 7 through 11, Vₙ₋₁, Vₙ, Vₙ₊₁, Vₙ₊₂, Vₙ₊₃, and Vₙ₊₄ indicate values of pixels before filtered and Vₙ₊₁′, Vₙ₊₂′, and Vₙ₊₃′ indicate values of pixels after filtered.

As described above, in an apparatus and method for filtering a blocking effect in an image according to the present invention, in the case of a blocky pattern, a threshold value varies with QP. Thus, since QP is large in an excessively compressed region, more deblocking filtering is performed. Since QP is small in a little compressed region, less deblocking filtering is performed. Also, deblocking filtering is performed only around a boundary where a blocking effect occurs, thereby effectively removing the blocking effect and preventing excessive blurring.

Also, in a method for filtering a blocking effect in an image according to the present invention, a blocking effect can be effectively removed even when at least one of two adjacent macroblocks in a frame picture is coded in a field mode.

While the present invention has been particularly shown and described with reference to exemplary embodiments thereof, it will be understood by those of ordinary skill in the art that various changes in form and details may be made therein without departing from the spirit and scope of the present invention as set forth in the following claims.

What is claimed is:

1. An apparatus for filtering a blocking effect in an image, the apparatus comprising:
a single blocky pattern searching unit searching for a single blocky pattern in a predetermined section adjacent to a boundary between image blocks;
a first filtering unit filtering a plurality of pixels on either side of the boundary if a first filtering condition is satisfied and filtering a plurality of pixels on either side of the boundary if the first filtering condition is not satisfied, when there is a single blocky pattern in the predetermined section;
a double blocky pattern searching unit searching for a double blocky pattern in the predetermined section if there is no single blocky pattern in the predetermined section;
a second filtering unit filtering a plurality of pixels on either side of the boundary if a second filtering condition is satisfied and filtering a plurality of pixels on either side of the boundary if the second filtering condition is not satisfied, when there is a double blocky pattern in the predetermined section; and
a third filtering unit filtering one pixel on either side of a boundary between 8×8 blocks if a third filtering condition is satisfied, when there is neither a single blocky pattern nor a double blocky pattern in the predetermined section or the difference between two pixels in the predetermined section is more than two times a quantization scale factor.

2. The apparatus of claim 1, wherein 10 pixels are included in the predetermined section.

3. The apparatus of claim 1, wherein a single blocky pattern is where there exists a step height between two sides of a boundary and the step height is the largest around the boundary among step heights of flat patterns.

4. The apparatus of claim 3, wherein the degree of flatness is the quantization scale factor/8+1 and the step height is less than two times the quantization scale factor.

5. The apparatus of claim 1, wherein a single blocky pattern is where there are two pixels on either side of a boundary, a step height of less than two times the quantization scale factor exists between two pixels, each being on either side of the boundary, and the difference between the two pixels is less than a predetermined threshold value.

6. The apparatus of claim 1, wherein the double blocky pattern is where at least two boundaries overlap and a step height exists over two pixels and is the largest around the boundaries among step heights of flat patterns.

7. The apparatus of claim 6, wherein the degree of flatness is the quantization scale factor/8+1 and the step height is less than two times the quantization scale factor.

8. The apparatus of claim 1, wherein the double blocky pattern is where there is one pixel in the boundary region, there are two pixels on either side of the boundary region, a step height of less than two times the quantization scale factor exists between two pixels, each being on either side of the boundary region, and the difference between the two pixels is less than a predetermined threshold value.

9. The apparatus of claim 1, wherein the first filtering unit filters three pixels if the first filtering condition is satisfied and filters two pixels if the first filtering condition is not satisfied.

10. The apparatus of claim 1, wherein the second filtering unit filters three pixels if the second filtering condition is satisfied and filters two pixels if the second filtering condition is not satisfied.

11. A method for filtering a blocking effect in an image, the method comprising:
(a) searching for a single blocky pattern in a predetermined section adjacent to a boundary between image blocks;
(b) filtering a plurality of pixels on either side of the boundary if a first filtering condition is satisfied and filtering a plurality of pixels on either side of the boundary if the first filtering condition is not satisfied, when there is a single blocky pattern in the predetermined section;
(c) searching for a double blocky pattern in the predetermined section if there is no single blocky pattern in the predetermined section;
(d) filtering a plurality of pixels on either side of the boundary if a second filtering condition is satisfied and filtering a plurality of pixels on either side of the boundary if the second filtering condition is not satisfied, when there is a double blocky pattern in the predetermined section; and
(e) filtering one pixel on either side of a boundary between 8×8 blocks if a third filtering condition is satisfied, when there is neither a single blocky pattern nor a double blocky pattern in the predetermined section or the difference between two pixels in the predetermined section is more than two times a quantization scale factor.

12. The method of claim 11, further comprising (b′) repeating (a) through (e) on the pixels filtered in (b).

13. The method of claim 11, wherein 10 pixels are included in the predetermined section.

14. The method of claim 11, wherein a single blocky pattern is where there exists a step height between two sides of the boundary and the step height is the largest around the boundary among step heights of flat patterns.

15. The method of claim 14, wherein the degree of flatness is the quantization scale factor/8+1 and the step height is less than two times the quantization scale factor.

16. The method of claim 11, wherein a single blocky pattern is where there are two pixels on either side of the boundary, a step height of less than two times the quantization scale factor exists between two pixels, each being on either side of the boundary, and the difference between the two pixels is less than a predetermined threshold value.

17. The method of claim 11, wherein a double blocky pattern is where at least two boundaries overlap and a step height exists over two pixels and is the largest around the boundaries among step heights of flat patterns.

18. The method of claim 17, wherein the degree of flatness is the quantization scale factor/8+1 and the step height is less than two times the quantization scale factor.

19. The method of claim 11, wherein a double blocky pattern is where there is one pixel in the boundary region, there are two pixels on either side of the boundary region, a step height of less than two times the quantization scale factor exists between two pixels, each being on either side of the boundary region, and the difference between the two pixels is less than a predetermined threshold value.

20. The method of claim 11, wherein step (b) filters three pixels if the first filtering condition is satisfied and filters two pixels if the first filtering condition is not satisfied.

21. The method of claim 11, wherein step (d) filters three pixels if the second filtering condition is satisfied and filters two pixels if the second filtering condition, is not satisfied.

22. A method for filtering a blocking effect in an image in which at least one of two adjacent blocks is coded in a field mode, the method comprising:
(a) filtering a plurality of pixels included in a top field of one of the two adjacent blocks on one side of a boundary between the two adjacent blocks and a plurality of pixels included in a top field of the other block on the other side of the boundary; and
(b) filtering a plurality of pixels included in a bottom field of one of the two adjacent blocks on one side of a boundary between the two adjacent blocks and a plurality of pixels included in a bottom field of the other block on the other side of the boundary.

23. The method of claim 22, wherein one of the two adjacent blocks includes first through fourth pixels that are sequentially located from the boundary, the fourth and second pixels are included in the top field of the block, and the third and first pixels are included in the bottom field of the block.

24. The method of claim 22, wherein the other block includes first through fourth pixels that are sequentially located from the boundary, the first and third pixels are included in the top field of the block, and the second and fourth pixels are included in the bottom field of the block.

25. The method of claim 22, wherein step (a) filters two pixels included in the top field of one of the two adjacent blocks on one side of the boundary between the two adjacent blocks and two pixels included in the top field of the other block on the other side of the boundary.

26. The method of claim 22, wherein step (b) filters two pixels included in the bottom field of one of the two adjacent blocks on one side of the boundary between the two adjacent blocks and two pixels included in the bottom field of the other block on the other side of the boundary.
